(19) United States
(12) Patent Application Publication
(10) Pub. No.: US 2007/0025006 A1
(43) Pub. Date: Feb. 1, 2007

(54) Sector format setting processing method for disk storage device and disk storage device

(75) Inventor: Kazuhito Ichihara, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/299,604

(22) Filed: Dec. 12, 2005

(30) Foreign Application Priority Data
Aug. 1, 2005 (JP) 2005-223116

(51) Int. Cl. G11B 27/36; G11B 5/09

(52) U.S. Cl. 360/31; 360/53

(57) ABSTRACT

A disk storage device has a plurality of disk faces and a plurality of heads, in which a different S/N is improved for each head. The disk face is formatted in a sector format with which the read/write characteristics become the optimum using the fact that the read/write characteristics differ depending on the sector length, so an improvement of the S/N ratio can be expected compared with a conventional recording/reproducing device using a single format, and the device yield rate and the device performance can be improved, and high recording density can be implemented.

### CROSS-REFERENCE TO RELATED APPLICATIONS

This application is based upon and claims the benefit of priority from the prior Japanese Patent Application No. 2005-223116, filed on Aug. 1, 2005, the entire contents of which are incorporated herein by reference.

### BACKGROUND OF THE INVENTION

1. Field of the Invention

The present invention relates to a sector format setting processing method for a disk storage device which records data on a disk by a head, and the disk storage device, and more particularly to a sector format setting processing method for a disk storage device which sets a sector format according to recording and reproducing characteristics, and the disk storage device.

2. Description of the Related Art

Along with the recent demands for data computerized processing, larger capacities are demanded for a medium storage device for a magnetic disk device and an optical disk device for storing data. For this, the track density and the recording density of the disk medium are increasing more and more.

In such a disk storage device, data is read/written by a head, so even a slight deviation of the recording and reproducing characteristics of the head and storage medium influences the device performance, generating a defective product which cannot present normal characteristics.

Therefore in the disk storage device, by performing test-writing each sector of the disk medium, a defective sector is detected from the result and then replacement and setting optimum recording power has been done (e.g. Japanese Patent Application Laid-Open No. H 7-192409 (FIG. 3)).

In this conventional method, a sector format of the data track is fixed, and various read conditions and write conditions of an individual device are optimized. For example, optimization is performed such that the S/N (signal/noise) ratio, which is a standard of signal quality, becomes appropriate. Along with the recent improvements of track density and recording density, it is becoming difficult for such an adjustment of the read and write conditions to guarantee a predetermined signal quality for all devices.

Also in recent mass production, a subtle adjustment in these conditions for an individual device leads to an increase in cost. This drops the yield rate of the device and a drop in the performance of the device (e.g. increase of retry count).

### SUMMARY OF THE INVENTION

With the foregoing in view, it is an object of the present invention to provide a sector format setting processing method for a disk storage device for improving the yield rate of the device by a sector format, and the disk storage device.

It is another object of the present invention to provide a sector format setting processing method for a disk storage device for improving the performance of the device by sector format, and the disk storage device.

It is still another object of the present invention to provide a sector format setting processing method for a disk storage device for automatically setting a sector format of which the recording/reproducing characteristics are the optimum and preventing deterioration in yield rate and performance of the device, and the disk storage device.

To achieve these objects, the present invention is a disk storage device has: at lest one disk medium having a plurality of disk faces; a plurality of heads for reading/writing the disk medium in sector units; and a control unit for controlling the read/write of the head in sector units, wherein the disk medium is formatted in a sector format with a different sector length with which the read/write characteristics become the optimum at least for each head.

The sector format setting processing method of the present invention has the steps of: formatting at least one disk medium having a plurality of disk faces in sector format with a different sector length with which the read/write characteristics become the optimum at least for each head; and reading/writing the disk storage medium in sector units by the head.

In the present invention, it is preferable that the disk medium is formatted in a sector format with a sector length with which the read/write characteristics become the optimum, the read/write characteristics being determined based on read/write characteristics acquired by writing test data on the sector format with a different sector length on the disk medium by each head, then reading the disk medium.

Also in the present invention, it is preferable that the control unit measures the read/write characteristics by writing test data on the sector format with a different sector length on the disk medium by each head, then reading the disk medium, and determines a sector format with a sector length with which the read/write characteristics of each of the heads become the optimum.

Also in the present invention, it is preferable that the disk medium is formatted in a sector format with a different sector length with which the read/write characteristics become the optimum at least for each head and for each track.

Also in the present invention, it is preferable that the disk medium is formatted in a sector format with a different sector length with which the read/write characteristics become the optimum at least for each head and for each zone having a bundle of a plurality of tracks.

Also in the present invention, it is preferable that the disk medium is formatted in a sector format with a different sector length with which the error rate, as the read/write characteristics, becomes lowest at lest for each head.

In the present invention, it is preferable that the disk medium is formatted in a sector format with a different sector length with which the S/N, as the read/write characteristics, becomes the optimum at least for each head.

Also in the present invention, it is preferable that the disk medium is formatted in a sector format with a different sector length with which most likelihood information, as the read/write characteristics, becomes the optimum at least for each head.

Also in the present invention, it is preferable that the control unit detects the deterioration of the read/write characteristics, saves data on a disk face corresponding to the head of which the deterioration has been detected, writes test data in a sector format with a different sector length on the disk face by the head, then reads the disk face and measures the read/write characteristics, and determines a sector format with a sector length with which the read/write characteristics of the head become the optimum.

Also in the present invention, it is preferable that the control unit has an LBA table corresponding to a sector format with the sector length, and reads/writes the disk medium by referring to the LBA table.

According to the present invention, a recording/reproducing device using a sector format with which read/write characteristics can be implemented using the fact that the read/write characteristics differ depending on the sector length, so an improvement of the S/N can be expected compared with a conventional recording/reproducing device using a single format, and device yield rate and device performance can be improved, and high recording density can be implemented.

### BRIEF DESCRIPTION OF THE DRAWINGS

FIG. 1 is a block diagram depicting the disk storage device according to an embodiment of the present invention;

FIG. 2 is a block diagram depicting the read/write system in FIG. 1;

FIG. 3 is a diagram depicting the sectors of the disk medium in FIG. 1;

FIG. 4 is a diagram depicting the short sector format of the sector in FIG. 3;

FIG. 5 is a diagram depicting the long sector format of the sector in FIG. 3;

FIG. 6 is a diagram depicting the relationship between S/N and the error rate of the sector formats of different sector lengths in FIG. 4 and FIG. 5;

FIG. 7 is a flow chart depicting the sector format setting processing before factory shipment according to an embodiment of the present invention;

FIG. 8 is a flow chart depicting the sector format setting processing after factory shipment according to another embodiment of the present invention;

FIG. 9 is a flow chart depicting the error rate measurement and the sector format decision processing in FIG. 7 and FIG. 8;

FIG. 10 shows the measurement tables in the processing in FIG. 9;

FIG. 11 shows the LBA table of the measurement result in FIG. 9; and

FIG. 12 shows an example of the LBA arrangement on the disk medium based on the LBA table in FIG. 11.

### DESCRIPTION OF THE PREFERRED EMBODIMENTS

Embodiments of the present invention will now be described in the sequence of disk storage device, sector format setting processing and other embodiments.

Disk Storage Device

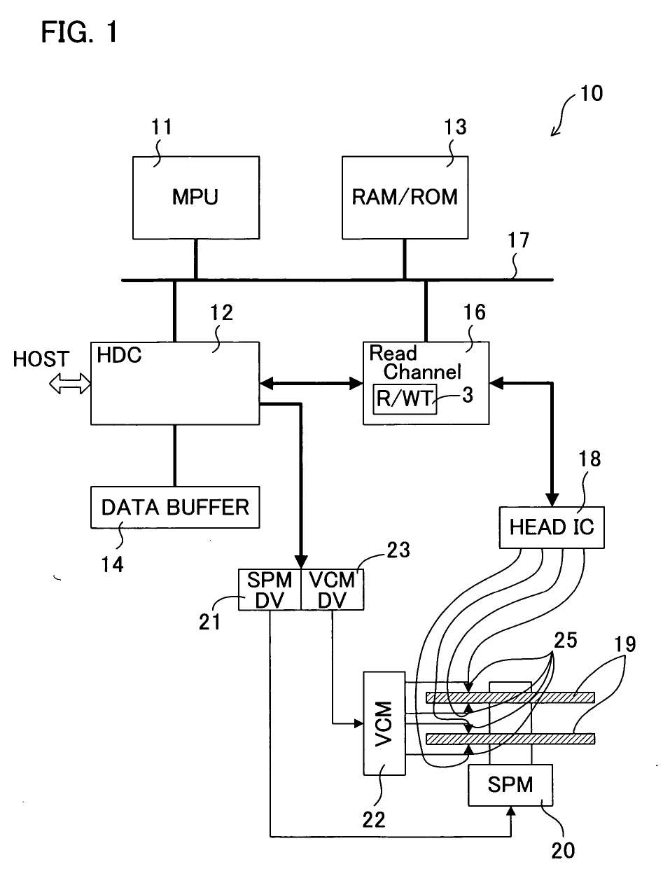

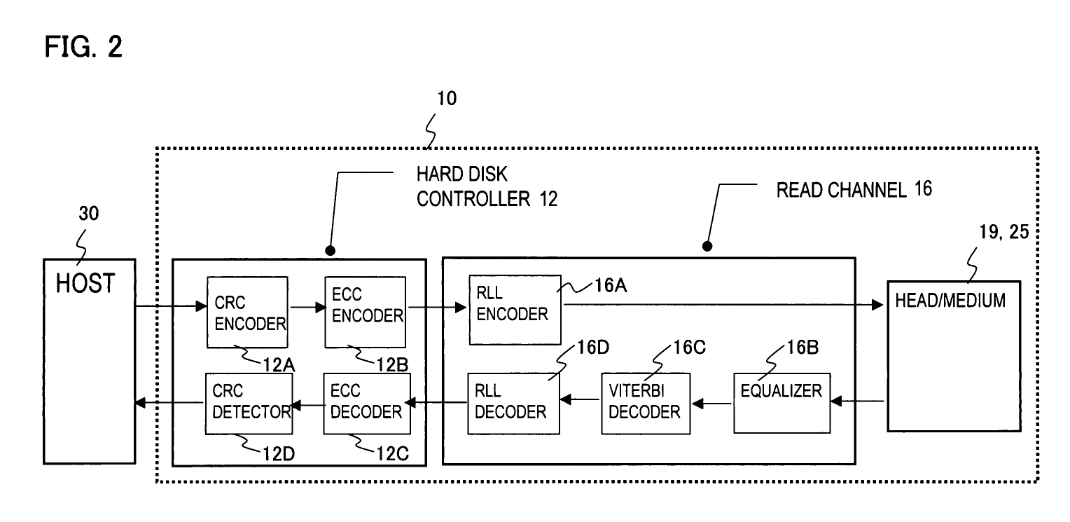

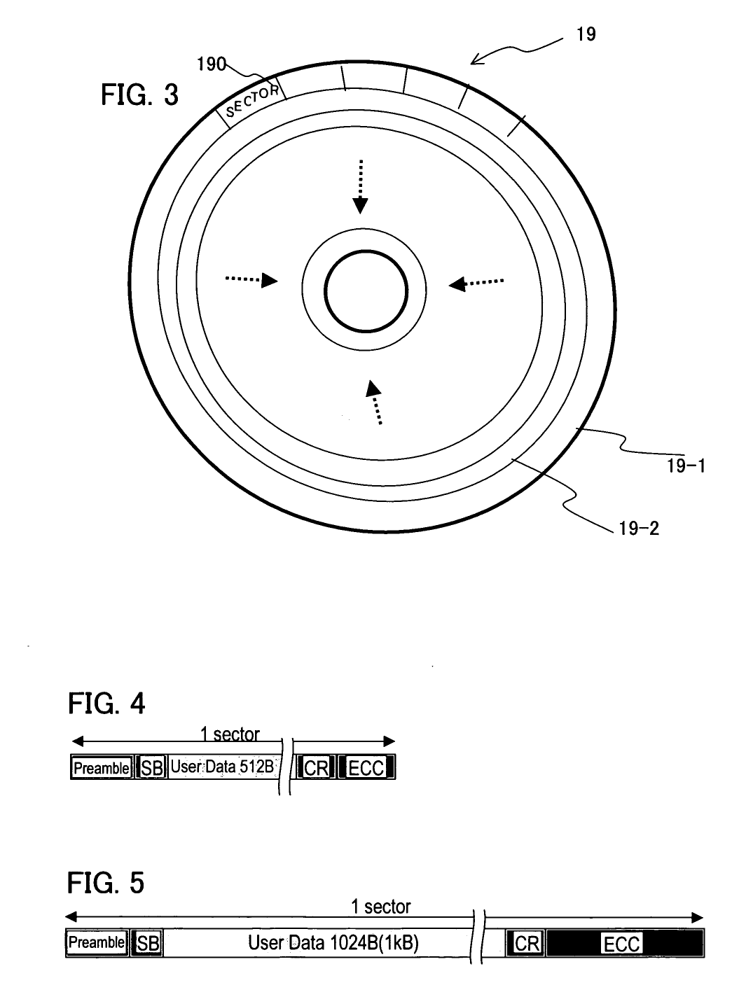

FIG. 1 is a block diagram depicting the disk storage device according to an embodiment of the present invention, FIG. 2 is a diagram depicting the signal path in FIG. 1, FIG. 3 is a diagram depicting the disk medium in FIG. 1, and FIG. 4 and FIG. 5 are diagrams depicting the sector format. FIG. 1 shows a magnetic disk device (Hard Disk Drive) for reading/writing data on a magnetic disk as an example.

As FIG. 1 shows, the magnetic disk device 10 is built in or connected to a personal computer (described later in FIG. 2), and is connected with the host of the personal computer (not illustrated in FIG. 1) via an interface cable, such as ATA (AT Attachment) (not illustrated).

The magnetic disk device 10 has a plurality (two in this case) of magnetic disks 19, a spindle motor 20 for rotating the magnetic disks 19, a plurality (four in this case) of magnetic heads 25 for reading/writing data on each face of the magnetic disks 19, and an actuator (VCM) 22 for moving the magnetic heads 25 in the radius direction (track crossing direction) of the magnetic disks 19.

Also as a control section, the magnetic disk device 10 further has an HDC (Hard Disk Controller) 12, data buffer 14, MPU 11, memory (RAM/ROM) 13, read channel circuit 16, head IC 18, spindle motor driver 21, VCM driver 23 and a bus 17 connecting these composing elements.

The HDC 12 has an interface control circuit having a task file for setting a task from a host, and a data buffer control circuit for controlling the data buffer 14. The read channel circuit 16 encodes write data, demodulates the read data, and generates write gate.

The data buffer 14 plays the role of the cache memory, stores the write data from the host, and stores the read data from the magnetic disk 19. And when write back is performed, the HDC 12 writes write data of the data buffer 14 on the magnetic disk 19, and at reading, the HDC 12 transfers the read data of the data buffer 14 to the host.

At writing, the head IC 18 supplies recording current to the magnetic head 25 according to the write data, and at reading, the head IC 18 amplifies the read signal from the magnetic head 25, and outputs it to the read channel 16. The spindle driver 21 drives the rotation of the spindle motor 20. The VCM driver 23 drives the VCM 22 which moves the magnetic head 25.

The MPU (Micro Processing Unit) 11 performs position control, read/write control and retry control of the magnetic head 25. The memory (ROM/RAM) 13 stores the data required for the processing of the MPU 11. In this read channel circuit 16, the read/write timing circuit 3 is disposed, and the MPU 11 in link with the timing circuit 3, executes read/write control.

As the block diagram of the read and write system in FIG. 2 shows, the user data, including binary patterns [0, 1], which are sent from the host computer 30, is input to the hard disk controller 12. In the hard disk controller 12, CRC (Cyclic Redundancy Check) is attached to the user data by the CRC encoder 12A for error correction detection, and ECC (Error Correcting Code) for error correction is attached by the ECC encoder 12B, and then the user data is input to the read channel circuit 16.

In the read channel circuit 16, the RLL (Run Length Limited) encoder 16A encodes the input data for enabling timing correction at reproducing data in PLL (Phase Locked Loop). And the output of the RLL encoder 16A is magnetically recorded to the disk 19 via the head IC 18 and the head 25.

On the other hand, at the head 25 the analog signal regenerated from the disk 19 is shaped by the equalizer 16B of the read channel circuit 16, so as to be a desired target waveform of such systems as PR4 (Partial Response Class 4), EPR4 (Extended PR 4), EEPR4 (Extended EPR4), and MEEPR4 (Modified EEPR4).

The shaped analog signal is decoded by the Viterbi decoder 16C, which is one maximum likelihood decoder to implement the PRML (Partial Response Maximum Likelihood) system, then is decoded by the RLL decoder 16D and is output from the read channel circuit 16. This read channel output is error-corrected by the ECC decoder 12C of the hard disk controller 12, then it is checked whether an error is corrected by the CRC detector 12D, and the result is transferred to the host computer 30.

FIG. 3 is a diagram depicting the track format of the magnetic disk 19, and the magnetic disk 19 has a plurality of concentric tracks 19-1, 19-2, - - - . Each track 19-1 is divided into a plurality of sectors 190. FIG. 4 is an example of the 512 byte sector format. Preamble is a known training pattern to be used for AGC (Automatic Gain Control) and PLL, and in many cases a repeat of “1100” (NRZ pattern) is used.

SB (Sync Byte) is a known pattern which indicates the breakpoint of the preamble section and data section, and two or more SBs (Sync Bytes) may be used to improve reliability.

After SB, the user data (512 bytes), CRC and ECC are recorded. The data is RLL-encoded on the magnetic recording medium 19, so the data size is slightly bigger than that before RLL encoding. The amount of the increase of the data size differs depending on the encoding ratio (before encoding/after encoding) of the RLL codes to be used. For example, if an encoding ratio of 16/17 is used, the user data becomes 512 bytes*16/17=544 bytes.

FIG. 5 is an example of the long sector format, which exceeds 512 bytes, which has been proposed. For example, in the case of the 1024 byte sector format, a user data double (=1024/512) of the prior art is recorded in one sector. An advantage of the long sector format is that the number of sector per track can be decreased compared with the 512 byte sector format, so Preamble and SB can be decreased and the line recording density can be decreased. In the case of the short sector format, such as 512 bytes, on the other hand, ECC and CRC can be executed for every 512 bytes, so the advantage is that burst errors can be less.

In a conventional magnetic recording/reproducing device, the data tracks from the outermost track to the innermost track in a disk shaped magnetic recording medium 19 (FIG. 3) all have the same 512 byte sector format, but even in the long sector format, the same single sector format is used for all the data tracks.

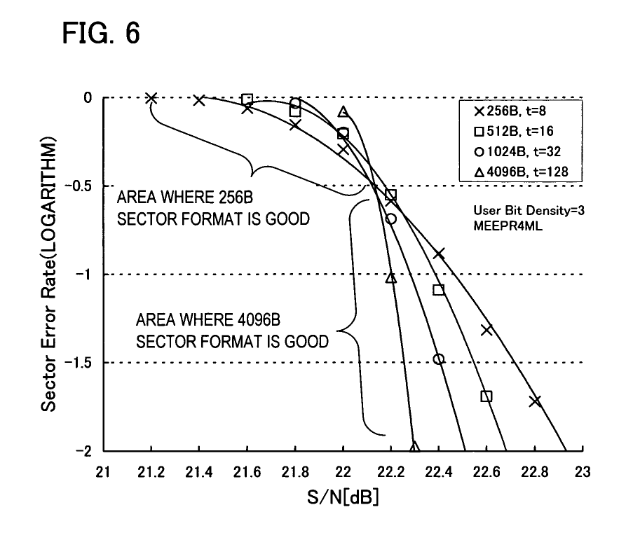

FIG. 6 shows the relationship between the S/N (isolated wave signal amplitude/noise execution value) and the sector error rate (read error sector/read sector) in each sector format of 256 bytes, 512 bytes, 1024 bytes and 4096 bytes, determined by computer simulation.

This computer simulation will be described. The simulation model in FIG. 2 is first created. In other words, simulation model is created so that an input signal is converted into a recording signal by the CRC encoder 12A, ECC encoder 12B and RLL encoder 16A, noise N is added to the analog waveform (called a Lorentz waveform), and this signal is converted into read data by the equalizer 16B, Viterbi decoder 16C, RLL decoder 16D, ECC decoder 12C and CRC detector 12D.

The amplitude N of the noise is changed with respect to the signal amplitude S, and the sector error rate at each S/N (dB) is measured. This sector error rate is indicated as a logarithm in FIG. 6, and if the sector error rate is “0” for example, the data is read 100 times and an error occurs 100 times. In other words, log (100/100)=log (1/1)=0. If the sector error rate is “−1”, data is read 100 times and an error occurs 10 times, in other words log (10/100)=log (1/10)=−1.

Using this model, data is input in each sector format of 256 bytes, 512 bytes, 1024 bytes and 4096 bytes, as mentioned above, so that the noise intensity is changed, and the sector error rate is measured while changing the S/N from “21.2” to “23”, and the result is plotted. Note that “t” in FIG. 6 is the number of ECC error correctable bits, and when ECC cannot be corrected according to this error rate, it is judged as an error sector. The recording density (User Bit Density) is “3”, and MEEPR4ML is used.

As the graph in FIG. 6 shows, as the S/N ratio increases the error rate decreases, but the way it decreases differs depending on the sector format. In other words, when S/N <22.1 dB, the 256 byte sector format, which is a short sector format, excels (has a lower error rate), but when S/N >22.1 dB, the 4096 byte sector format, which is a long sector format, excels (has a lower error rate).

In other words, the recording/reproducing characteristics change depending on the length of the sector format. Therefore in the outermost track and innermost track of the magnetic recording medium 19, the magnetic recording/reproducing characteristics (S/N) differ depending on the data transfer speed and the recording density, and it can be said that a single sector format excels in all the data tracks of the medium. Normally a magnetic recording/reproducing device has two or more magnetic recording/reproducing heads, so here as well it can also be said that a single sector format excels in all the head because of the dispersion of the magnetic recording/reproducing characteristics (e.g. S/N) of each head.

Therefore in the present invention, an optimized sector format is applied to each track from the outermost track to the innermost track of the disk 19 of the magnetic recording/reproducing device, or to each zone or to each head, so compared with a conventional magnetic recording/reproducing device with a single format, the device yield rate, device performance and recording density can be improved.

Sector Format Setting Processing

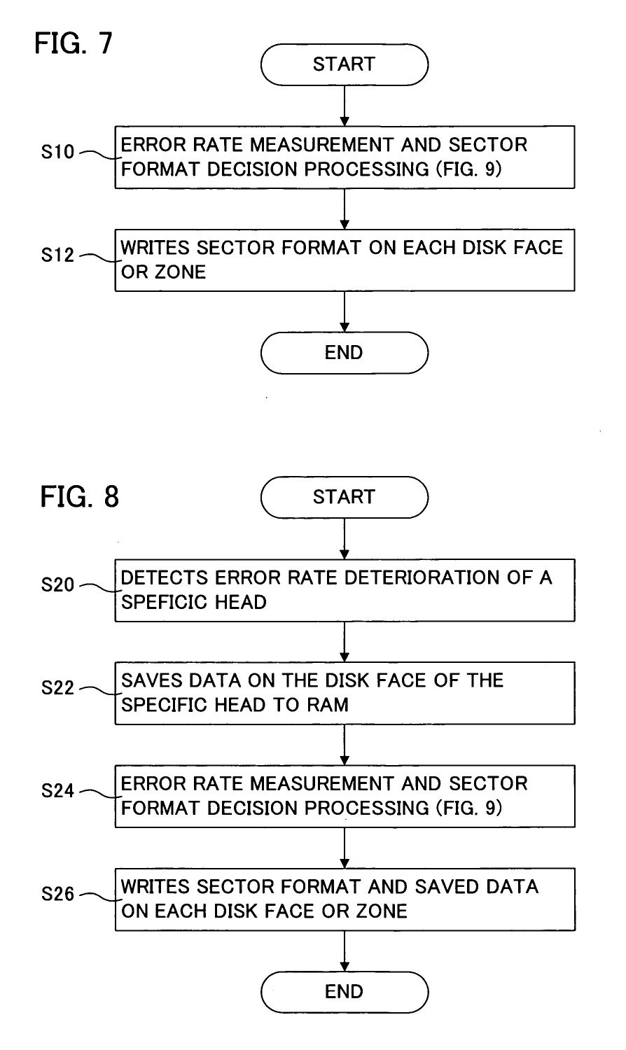

Now the processing for optimizing the sector format for each disk and head will be described. FIG. 7 is a flow chart depicting the sector format processing before factory shipment.

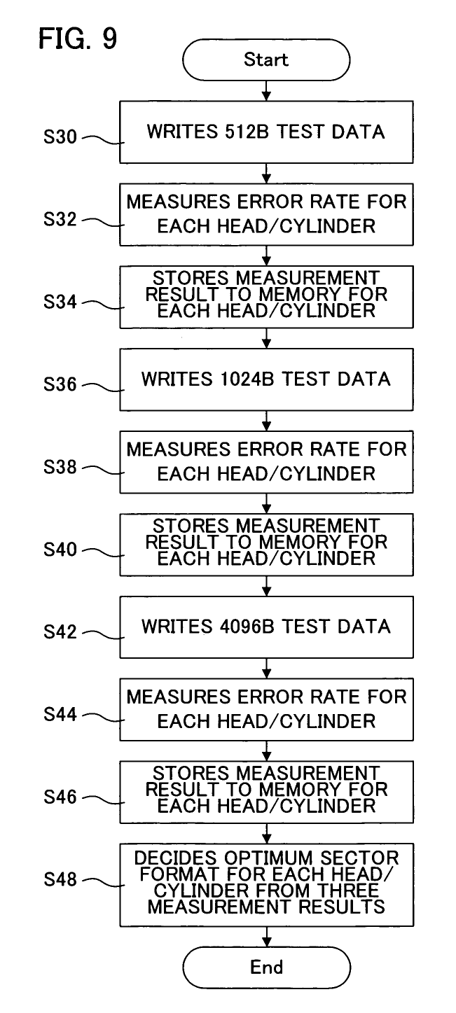

(S10) As described in FIG. 9, the error rate is measured for each head, or for each zone of each disk face, or for each track by the device in FIG. 1, and a sector format, with which the error rate is lowest, is determined for each head or for each zone of each disk.

(S12) Then the determined sector format is written on each disk face, each zone and each track by each head. And the processing ends.

FIG. 8 is a flow chart depicting the sector format processing after factory shipment.

(S20) When the device in FIG. 1 is operating, the error rate of each head is accumulated by SMART (Self Monitoring Analysis Report Technology) information. So by referring to the SMART information, it is detected whether the error rate deteriorated in a specific head.

(S22) The data on the corresponding disk face is read by the head of which the error rate is deteriorated, and is saved to the data buffer 14.

(S24) As will be described in FIG. 9, the error rate of the head is measured, and a sector format, of which the error rate is lowest in the head, is determined.

(S26) Then the saved user data is written to the corresponding disk face by the head in the determined sector format, and the processing ends.

It is preferable that the processing to determine the optimum format is performed by an external device, such as a testing device connected to the disk storage device, only before shipment at the factory. Then many disk storage devices can be simultaneously processed. The processing in FIG. 8 is executed by the CPU 11 in the disk storage device 10. To perform both of these processing, a processing program is installed in the CPU 11 in the disk storage device 10.

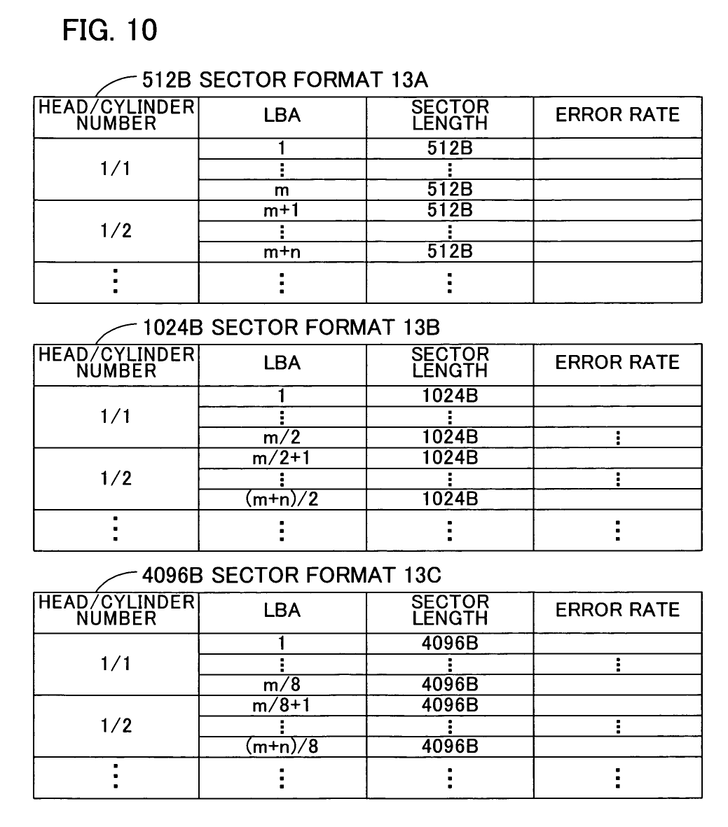

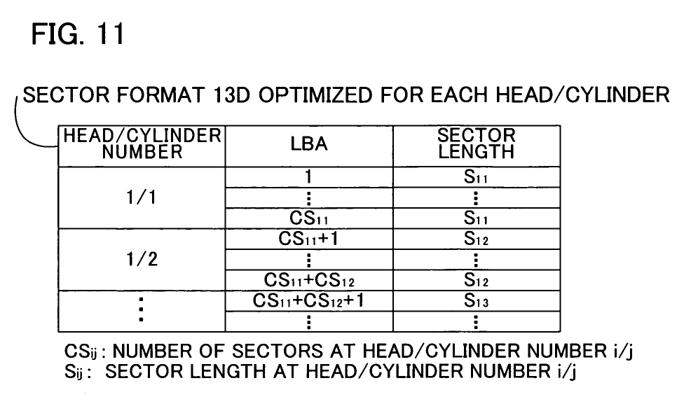

Now the optimum sector format decision processing will be described using FIG. 9 with reference to FIG. 10 and FIG. 11. This is an example where the sector format is decided for each head and for each cylinder, and the sector formats of 512 bytes, 1024 bytes and 4096 bytes will be described as examples.

Before starting decision processing, the CPU 11 creates the 512 byte, 1024 byte and 4096 byte sector format tables 13A, 13B and 13C, shown in FIG. 10, in the RAM 13. These sector format tables 13A, 13B and 13C store an LBA for storing a head/cylinder number (corresponds to the track number), the sector length thereof and the error rate thereof. For example, in the case of the head/cylinder number 1/1, the LBA becomes half “1”-“m/2” in the 512 byte sector format, and the LBA becomes double “1”-“m/8” in the 4096 byte sector format. And the error rate is measured in LBA units.

(S30) The CPU 11 refers to the 512 byte sector format table 13A, and writes the 512 byte test data to each head (on the disk face) and to each cylinder using the recording path in FIG. 2.

(S32) The CPU 11 issues the read command of the write data, reads the 512 byte test data using the reproducing path in FIG. 2, and measures the error rate.

(S34) The CPU 11 saves this measurement result in the table 13A in FIG. 10 for each head/cylinder.

(S36) Then the CPU 11 refers to the 1024 byte sector format table 13A, and writes the 1024 byte test data to each head (on the disk face) and to each cylinder using the recording path in FIG. 2.

(S38) The CPU 11 issues the read command of the write data, reads the 1024 bytes test data using the reproducing path in FIG. 2, and measures the error rate.

(S40) The CPU 11 saves the measurement result in the table 13B in FIG. 10 for each head/cylinder.

(S42) The CPU 11 refers to the 4096 byte sector format table 13C, and writes the 4096 byte test data to each head (on the disk face) and each cylinder using the recording path in FIG. 2.

(S44) the CPU 11 issues the read command of the write data, reads the 4096 byte test data using the reproducing path in FIG. 2, and measures the error rate.

(S46) The CPU 11 saves this measurement result in the table 13C in FIG. 10 for each head/cylinder.

(S48) An optimum sector format is decided for each head/cylinder from the three measurement results. In other words, a sector format, of which the error rate is lowest, is decided from the error rates of each head/cylinder of the tables 13A, 13B and 13C, the LBA of the head/cylinder is decided by this sector format, and the LBA table 13D, shown in FIG. 11, is created. In this table 13D, CSij is a sector length of the head/cylinder number i/j, and Sij is a number of sectors in the head/cylinder number. And the processing ends.

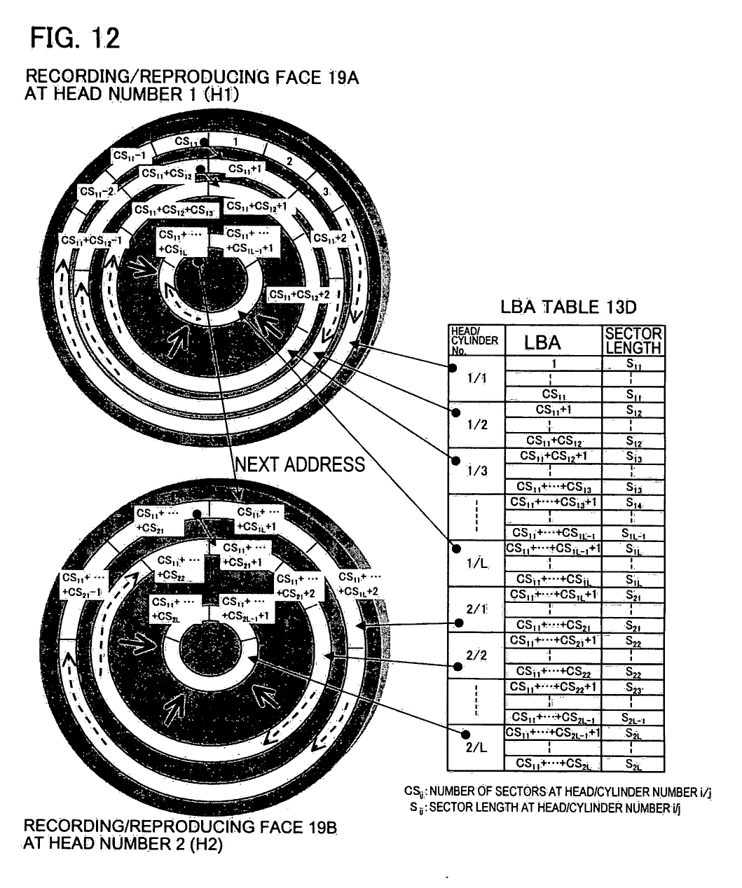

FIG. 12 is an example of the arrangement of LBA on the disk 25 based on this LBA table 13D, where the sector size is changed for each head/cylinder. As FIG. 12 shows, on the disk face 19A with the head number 1, L number of sectors with sector length Sij of the respective cylinder are arranged for the cylinder numbers “1”-“L”, and on the disk face 19B with the head number 2, L number of sectors with the sector length Sij of the respective cylinder are arranged for the cylinder numbers “1”-“L”, and on the disk faces 19A and 19B, the final address and the next address are continuous.

At read/write, the CPU 11 refers to the LBA table 13D, and controls the read/write in sector units.

In this way, the sector format is changed for each combination of the m number of heads mounted on the magnetic recording/reproducing device and the n number of tracks, and the error rate thereof is measured, and an optimum sector format is decided, as shown in the table in FIG. 11. By formatting according to the table in FIG. 11, a magnetic recording/reproducing device having an optimum sector format can be implemented.

For simplification, the sector format may be optimized not for each track but for each zone, which consists of a plurality of tracks. And instead of optimizing with the error rate, a parameter correlated to the error rate (e.g. S/N and likelihood information in the maximum likelihood decoder 16C) may be used.

Also to handle the change of the magnetic recording/reproducing characteristics due to age deterioration, a format may be automatically optimized many times with a predetermined interval, or according to the deterioration of the performance (e.g. error rate, S/N, likelihood information in the maximum likelihood decoder 16C).

By the present invention, a recording/reproducing device using an optimized sector format can be implemented, so about a 0.2 dB or more improvement of S/N can be expected compared with a conventional magnetic recording/reproducing device using a single format, and the device yield rate and device performance can be improved, and high recording density can be implemented.

Other Embodiments

In the above embodiment, the disk storage device was described using a magnetic disk device, but the present invention can be applied to an optical disk, magneto-optical disk and other storage medium. The interface is not limited to ATA, but can be applied to other interfaces. Also a disk device with four disk faces was used for description, but the present invention can also be applied to devices with a different number of disk faces, such as a disk device with two disk faces.

Even if the LBA range is set, the host 30 can operate logical space by being notified.

The present invention was described by embodiments, but the present invention can be modified in various ways within the scope of the essential character of the present invention, and these shall not be excluded from the scope of the present invention.

Since the disk medium is formatted at least for each head in a sector format with which the read/write characteristics become the optimum, using the fact that the read/write characteristics differ depending on the sector length, an improvement in S/N can be expected compared with a conventional magnetic recording/reproducing device using a single format, the device yield rate and device performance can be improved, and high recording density can be implemented.

What is claimed is:

1. A disk storage device comprising:
at least one disk medium having a plurality of disk faces;
a plurality of heads for reading/writing the disk medium in sector units; and
a control unit for controlling the read/write of the head in sector units,
wherein the disk medium is formatted in a sector format with a different sector length with which read/write characteristics become the optimum at least for each head.

2. The disk storage device according to claim 1,
wherein the disk medium is formatted in a sector format with a sector length with which the read/write characteristics become the optimum, the read/write characteristics being determined based on read/write characteristics acquired by writing test data on the sector format with the different sector length on the disk medium by each head, then reading the disk medium.

3. The disk storage device according to claim 2,
wherein the control unit measures the read/write characteristics by writing test data on the sector format with the different sector length on the disk medium by each head, then reading the disk medium, and determines a sector format with a sector length with which the read/write characteristics of each of the heads become the optimum.

4. The disk storage device according to claim 1,
wherein the disk medium is formatted in a sector format with a different sector length with which the read/write characteristics become the optimum at least for each head and for each track.

5. The disk storage device according to claim 1,
wherein the disk medium is formatted in a sector format with a different sector length with which the read/write characteristics become the optimum at least for each head and for each zone having a bundle of a plurality of tracks.

6. The disk storage device according to claim 1,
wherein the disk medium is formatted in a sector format with a different sector length with which the error rate, as the read/write characteristics, becomes lowest at least for each head.

7. The disk storage device according to claim 1,
wherein the disk medium is formatted in a sector format with a different sector length with which S/N ratio, as the read write characteristics, becomes the optimum at least for each head.

8. The disk storage device according to claim 1,
wherein the disk medium is formatted in a sector format with a different sector length with which likelihood information, as the read/write characteristics, becomes the optimum at least for each head.

9. The disk storage device according to claim 3,
wherein the control unit detects the deterioration of the read/write characteristics, saves the data on a disk face corresponding to the head of which the deterioration has been detected, writes test data in a sector format with the different sector length on the disk face by the head, then reads the disk face and measures the read/write characteristics, and determines a sector format with a sector length with which the read/write characteristics of the head becomes the optimum.

10. The disk storage device according to claim 1,
wherein the control unit has an LBA table corresponding to a sector format with the sector length, and reads/writes the disk medium by referring to the LBA table.

11. A sector format setting processing method, comprising the steps of:
formatting at least one disk medium having a plurality of disk faces in sector format with a different sector length with which the read/write characteristics become the optimum at least for each head; and
reading/writing the disk storage medium in sector units by the head.

12. The sector format setting processing method for a disk storage device according to claim 11,
wherein the formatting step further comprises the steps of:
writing test data in a sector format with the different sector length on the disk medium by each head;
measuring read/write characteristics by reading the disk medium; and
determining a sector format with a sector length with which the read/write characteristics become the optimum from the measurement result.

13. The sector format setting processing method for a disk storage device according to claim 12,
wherein the formatting step is executed by a control unit of the disk storage device.

14. The sector format setting processing method for a disk storage device according to claim 11,
wherein the formatting step further comprises a step of formatting the disk medium in a sector format with a different sector length with which the read/write characteristics become the optimum at least for each head and for each track.

15. The sector format setting processing method for a disk storage device according to claim 11,
wherein the formatting step further comprises a step of formatting the disk medium in a sector format with a different sector length with which the read/write characteristics become the optimum at least for each head and for each zone having a bundle of a plurality of tracks.

16. The sector format setting processing method for a disk storage device according to claim 11,
wherein the formatting step further comprises a step of formatting the disk medium in a sector format with a different sector length with which the error rate of the read/write characteristics becomes the minimum at least for each head.

17. The sector format setting processing method for a disk storage device according to claim 11,
wherein the formatting step further comprises a step of formatting the disk medium in a sector format with a different sector length with which the S/N ratio as the read/write characteristics becomes the optimum at least for each head.

18. The sector format setting processing method for a disk storage device according to claim 11,
wherein the formatting step further comprises a step of formatting the disk medium in a sector format with a sector length with which likelihood information as the read/write characteristics becomes the optimum at least for each head.

19. The sector format setting processing method for a disk storage device according to claim 13, further comprises:
a step of detecting the deterioration of the read/write characteristics of the head, and saving data on a disk face corresponding to the head of which the deterioration was detected;
a step of writing test data in a sector format with the different sector length on the disk face by the head, then reading the disk face and measuring the read/write characteristics; and
a step of determining a sector format with a sector length with which the read/write characteristics of the head becomes the optimum.

20. The sector format setting processing method for a disk storage device according to claim 11, wherein the read/write step further comprises a step of read/writing the disk medium by referring to an LBA table corresponding to a sector format with the sector length.
